(19) United States
(12) Patent Application Publication
(10) Pub. No.: US 2026/0138704 A1
(43) Pub. Date: May 21, 2026

(54) Air Spring Extender

(71) Applicant: Eko Sport, Inc., Grand Junction, CO (US)

(72) Inventors: Sean Mailen, Grand Junction, CO (US); Noah Sears, Grand Junction, CO (US)

(73) Assignee: Eko Sport, Inc., Grand Junction, CO (US)

(21) Appl. No.: 19/387,823

(22) Filed: Nov. 13, 2025

Related U.S. Application Data
(60) Provisional application No. 63/721,117, filed on Nov. 15, 2024.

(51) Int. Cl. B62K 25/08; B62K 21/04; B62K 25/04

(52) U.S. Cl. CPC B62K 25/08; B62K 21/04; B62K 2025/048

(57) ABSTRACT

A suspension system includes an air spring. The air spring includes a chamber that extends on both sides of a crown. An extended cap may be attached to a stanchion. A valve may be incorporated into the cap, and the valve may be contained within the volume of the cap. An extender may be positioned between the stanchion and the cap. The cap, the extension, and the stanchion may contact a shoulder within a cavity through the crown.

### BACKGROUND OF THE INVENTION

The present disclosure relates to a suspension system for a bicycle. More specifically, the present design relates to a suspension system for a bicycle that includes an air spring. Further, the present design relates to a configuration on one leg of a suspension that includes a configuration that increases the spring air volume without affecting the distance between the head and the axle.

A conventional front fork assembly is shown in FIGS. 2-4. As may be seen first in FIG. 2, the conventional front fork 272 may conventionally have a first leg 274 and a second leg 278. The top end 202 of the suspension system 272 may be attached to handlebars or another steering system, manipulable by a rider to set and change the direction of the vehicle. The bottom end 204 of the suspension system 272 may include a first bracket 206 and a second bracket 208 that are configured to allow an axle 210 to pass therethrough. The axle 210 may include a quick release 211. In operation, a hub and wheel (not shown) may be mounted in surrounding fashion to the axle 210.

A simplified partial cross section of the conventional fork 272 is shown in FIG. 3. As will be apparent to one of ordinary skill in the art, the first leg 274 may include an air spring, as is conventional, and may be at least partially filled with a compressible fluid, such as air. The second leg 278 may include conventional damping structures. The second leg 278 may be at least partially filled with an incompressible fluid. FIG. 4 is a close view of the cross section of FIG. 3 showing the area within the dashed lines labeled 4 on FIG. 3. As may be seen in FIG. 4, an annular stanchion 400 may be inserted into an aperture 402 that passes through the crown 404 until it contacts a side of a shoulder 406. A cap 408 is then threadably connected to the stanchion 400 using mating threads 410. Conventionally, a Schrader valve or any of a conventional set of valves and adjusters 412 penetrate through the cap 408 and into the cavity or volume 407 within the stanchion 400. In many embodiments, a crown top surface 414 may be adjacent the aperture 402. The crown top surface 414 may conventionally be annular.

Conventionally, bicycle suspensions have low weight, low friction, adjustable spring support, a convenient adjustment for rebound damping, and an on-the-fly adjustment to raise compression damping and/or spring rate to a high value for climbing and sprinting. Air springs are often used in bicycle suspensions because of their light weight and small number of parts. However, air springs can be limited in adjustability because the spring behavior is set by the initial spring geometry. The travel distance is often limited because the distance between the axle of a wheel and the handlebars cannot exceed a certain distance without causing discomfort to a rider. Accordingly, it is complicated to increase the size of the air chamber within the existing structure.

Some might consider lengthening the stanchion to extend above the steering crown. However, such a configuration does not function well. One reason is the interference fit between the stanchion and the crown is inadequate to keep the stanchion from slipping within the crown when under load. Extending the stanchion over the crown can also cause the top of the stanchion to interfere with other parts of the frame and create an unpleasant ride.

In addition, extending stanchions above the crown, especially considering this case where only one side would be extended, provides difficulties in manufacturing and asymmetrical assembly methods. One side (damper side) would likely follow the common method of a pressed in tube while the air spring side would have a longer tube that extends through the crown and is clamped to mate the crown and stanchion together. This construction forces what was a shared tube length and geometry, to become two different tubes of different design. It also means the only crown to stanchion connection on the air side is a clamp in a single position which is not ideal considering its lack of interference fit and material lip or shoulder to prevent movement axially. Dual crown forks that clamp stanchion tubes in two spots with an upper and lower crown increase the mate quality, but with increased complexity and weight.

These limitations in how the air spring in the suspension system can be configured have led to the adoption of conventional designs that are similar to those shown in FIGS. 2-4. While each manufacturer includes various features that they believe make the ride function superior, the general configuration remains the same across manufacturers.

Accordingly, in many embodiments according to the present disclosure, it may be desirable to incorporate a structure that allows for the assembly process and dimensions to remain as conventional, while allowing for an increased air capacity in the air spring chamber. Further, it may be desirable to minimize the extension of the air spring chamber over the crown. The inclusion of varying types of structures that can create these desirable results is advantageous.

### BRIEF SUMMARY OF THE INVENTION

The present disclosure is directed to a shock absorber for a bicycle having various desirable features.

In one embodiment, a shock absorber includes a cap. The cap may be configured to attach to a top end of a stanchion. The cap may have an interior volume of at least 6 ml.

The cap may have a top face. The cap may have at least one side extending from the top face. The at least one side may terminate in an end surface. The end surface of the at least one side may define a plane.

The interior volume may be defined by an interior surface of the top face, an interior surface of the at least one side and the plane defined by the end surface. The interior volume may be continuous. The at least one side may be continuous around a periphery of the top face. The cap may define an aperture, and the interior volume may be measured as if the aperture were a continuous surface. The interior volume may extend from an interior surface of the top face to a top of a stanchion to which the cap is configured to be attached.

In another embodiment, a shock absorber includes a cap and a spring control. The cap may be configured to be assembled to a stanchion. The cap may include an open end surface. The cap may have a cap length. The cap may define an aperture spaced from the open end surface. The spring control may be positioned in the aperture and may have a spring control length.

The cap length may be the greatest longitudinal distance between a plane defined by the open end surface of the cap and a plane defined by the points on the cap the furthest from the plane of the open end. The spring control length may be the distance between a top surface of the spring control and a bottom surface of the spring control. The cap length may be greater than the spring control length.

The spring control may be a valve. The spring control may be an adjuster.

The cap may have at least one side extending from the top face. The at least one side may include a threaded portion spaced from the top cap by a second distance. The at least one side may include a finger configured to engage a crown.

In another embodiment, a shock absorber may include a crown, a stanchion, an extender, and a top face. The crown may have an aperture with an inward-projecting shoulder. The crown may have a top surface adjacent the aperture. The stanchion may be annular and may be configured to be positioned in the aperture in contact with a first side of the shoulder. The extender may be annular and may have a first end and a second end. The first end may be configured to be attached to the stanchion and to be in contact with at least a second side of the shoulder. The top face may be configured to be attached to the second end of the extender and spaced from the crown. The top face may have an interior surface. A portion of the interior surface of the top face may be longitudinally spaced above the crown.

The annular extender may be integrally formed with the top face. The annular extender may be separate from the top face. A portion of the stanchion may extend upwardly from the crown. The extender may substantially surround at least a portion of the upwardly projecting portion of the stanchion. The top face and the annular extender may be positioned adjacent one another.

The spring control may be attached to the cap. The spring control may have a first end on a first side of the top face and a second end on a second side of the top face. An interior of the stanchion may define a volume, and the spring control may be positioned outside the volume. The volume of the stanchion and the volume of the cap may be continuous.

The volume of the stanchion and a volume of the cap may be continuous.

The at least a portion of the interior surface of the top face may be longitudinally spaced at least about 2.25 mm above the crown top surface.

### BRIEF DESCRIPTION OF THE SEVERAL VIEWS OF THE DRAWINGS

FIG. 1 is a perspective view of a vehicle in which a shock absorber according to the disclosure can be incorporated.

FIG. 2 is a side view of a conventional prior art shock absorber;

FIG. 3 is a simplified partial sectional view of the conventional shock absorber according to FIG. 2;

FIG. 4 is an enlarged view of the area enclosed by the circle identified as 4 in FIG. 3;

FIG. 5 is a partial side view of one embodiment of a shock absorber according to the disclosure;

FIG. 6 is a close perspective view of the embodiment of FIG. 5 near the crown;

FIG. 7 is a cross-sectional view of the shock absorber of FIG. 5;

FIG. 8 is a partial cross-sectional view of the embodiment of FIG. 7 in the circle labeled 8;

FIG. 9 is a partial cross-sectional view like that of FIG. 8 showing an alternative embodiment;

FIG. 10 is a partial cross-sectional view like that of FIG. 8 showing a variation of the alternative embodiment of FIG. 9;

FIG. 11 is partial cross-sectional view like that of FIG. 8 showing another alternative embodiment;

FIG. 12 is a chart showing a comparison of the fork travel and force for various configurations, including using one of the embodiments above;

FIG. 13 is a cross-sectional view of the embodiment of FIG. 8 showing the cap in isolation;

FIG. 14 is a perspective view of the cap of FIG. 13 in isolation;

FIG. 15 is a partial cross-sectional view like that of FIG. 8 showing yet another alternative embodiment; and

FIG. 16 is a partial cross-sectional view like that of FIG. 8 showing yet another alternative embodiment.

In describing the preferred embodiment of the invention, which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

In this detailed description, various terms relating to direction may be used. The elements discussed herein relate to a bicycle. Because, in its operable position, a bicycle is oriented generally vertically, i.e., perpendicular to the ground, the direction terms refer to the position of an element relative to gravity when the bicycle is in its operable position. Accordingly, for example, the term “downwardly” refers to the direction towards the ground when the bicycle is in its operable position, and the term “forwardly” relates to a direction towards a front wheel of the bicycle when it is in its operable position. Further, the terms “inboard” and “outboard” may be used. The term “inboard” describes a position between one item and a vertical plane substantially bisecting the bicycle. The term “outboard” describes a position of an object further from the vertical center plane of the bicycle. In addition, the terms “bicycle” and “bike” are used herein interchangeably. A person having ordinary skill in the art will understand that if something is referred to as one, it can refer to the other.

In the present disclosure, the suspension structure may be described as it relates to a bicycle. However, the suspension structure described in the present embodiments may instead be applied to other vehicles. The present suspension structure may be used with vehicles having a different number of wheels, for example. The suspension structure may be used in connection with a motorized vehicle. In the present disclosure, the terms “fork”, “suspension” and “shock absorber” may be used somewhat interchangeably. A person of ordinary skill in the art is able to understand the nuances between these terms and understand their use interchangeably in the disclosure. The present disclosure describes a suspension system that may be at least partially filled with a compressible gas and at least partially with a substantially incompressible fluid. In the descriptions herein, it will be understood by a person having ordinary skill in the art that the pressure within the suspension unit at the beginning of a suspension stroke may be substantially in equilibrium throughout the suspension system. A user may select from a variety of pressures within the suspension unit, depending on the user's preferences regarding ride and handling and the demands of a particular course the rider desires to ride. These factors are all well-known in the art and are not described in detail herein.

In the description and claims, various parts may be referred to numerically, such as by “first valve”, “second valve”, and the like. When the parts are numbered in such a manner, it will be understood by a person having ordinary skill in the art that any of the parts in that category could be understood to be the “first” or the “second” or any other number. When these descriptors are used, it is to assist the person of ordinary skill in the art to distinguish among like items.

The shock absorber device disclosed is shown in one leg of the bicycle fork. Alternatively, it can easily be adapted to serve as a shock absorber for the rear wheel of a bicycle. This alternative embodiment is not specifically illustrated herein. However, a person having ordinary skill in the art is able to make the appropriate, known, standard design changes to adapt the design to a rear shock without undue experimentation.

The structures described herein may be applied to either a front or rear suspension of a vehicle, most particularly a bicycle. The remaining structures present in the suspension may be illustrated and may be described in at least a cursory fashion. However, these structures are not critical to the use of the embodiments described herein. The present embodiments could be incorporated with other suspensions that use a compressible gas and an incompressible fluid. Accordingly, the suspension system elements shown should not be construed as being limiting to the embodiments described.

In general, persons of ordinary skill in the art are familiar with the structural and functional differences and limitations between shock absorbers and can make the necessary modifications to use the structures described herein in context. However, a person of ordinary skill in the art is able to understand that any of the disclosed embodiments could, in theory, be used in another suspension system in current operation or later developed.

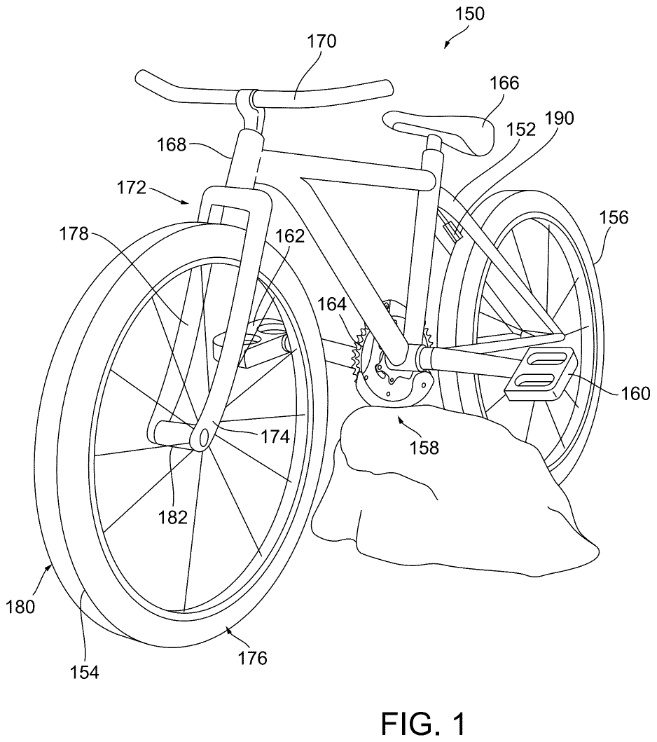

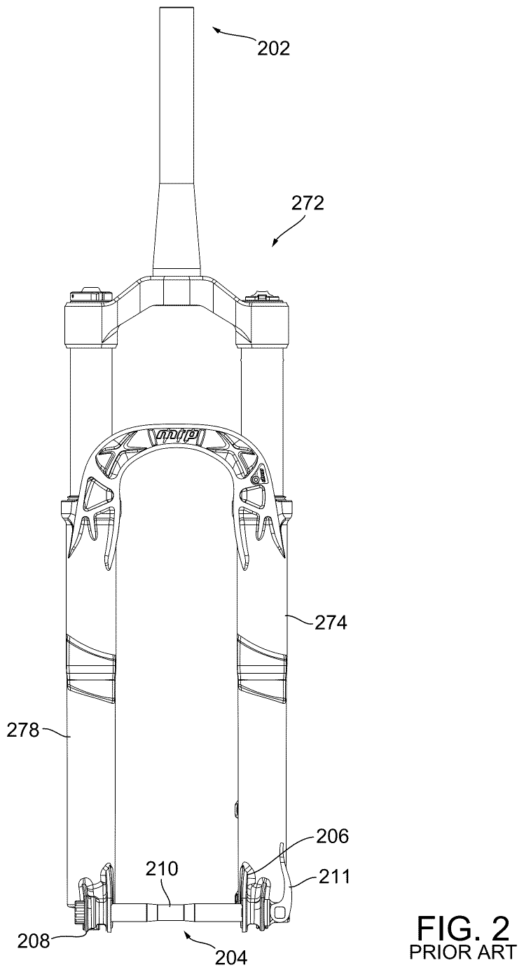

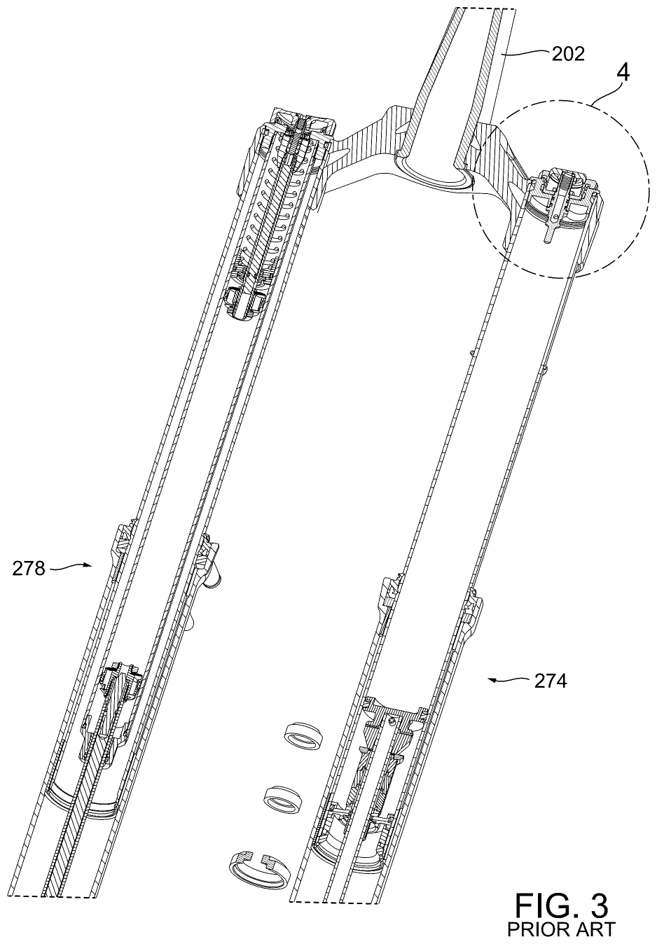

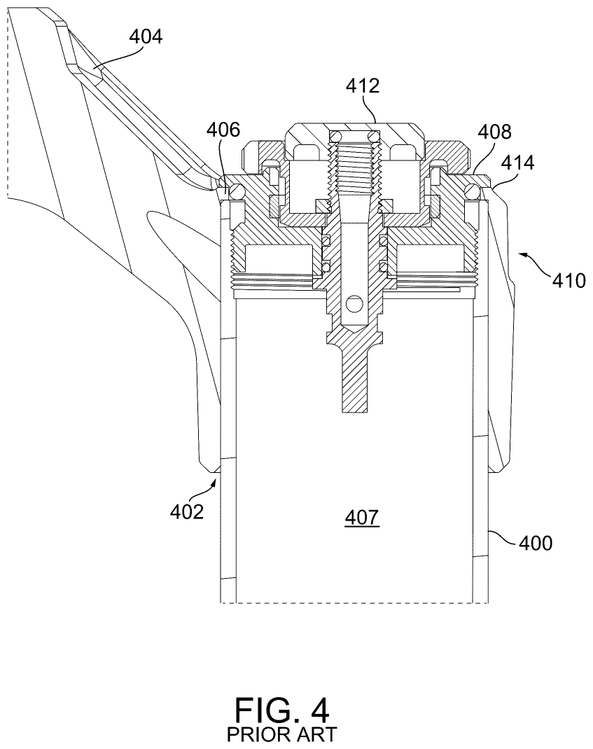

The overall configuration of the present device in the context of a vehicle is shown in FIG. 1. Many of the parts are shown schematically in this FIG., in an overall configuration, rather than illustrating the details of the design. The present shock absorbers are configured to be primarily used with a pedaled bicycle, such as the bicycle 150. The device could be used with a powered bicycle, a motorcycle, a moped, or similar vehicle. The bicycle 150 may include a frame 152, a front wheel 154, and a rear wheel 156. The bicycle 150 may further include a drive system 158 that conventionally includes a first pedal 160 and a second pedal 162 positioned generally opposite one another. When a user uses motive power, the user alternatingly presses the first pedal 160 and the second pedal 162. Each of the first pedal 160 and the second pedal 162 is conventionally attached to a front chain ring 164. A conventional chain (not shown) transmits the driving force from the pedals 160, 162, through the front chain ring 164 to a rear chain ring (not shown). The rear chain ring is secured to the rear wheel 156, causing it to rotate about an axle passing therethrough (not shown) and thereby causing the bicycle 150 to move. The bicycle frame 152 conventionally allows for the attachment of a seat 166 that a user sits on when using the pedals 160 and 162. The bicycle frame 152 also conventionally includes a head 168. The head 168 allows for the attachment of handlebars 170 that further attach through the head 168 to a front fork 172. The front fork 172 conventionally has a first leg 174 that extends on one side 176 of the front wheel 154 and a second leg 178 that extends on an opposite side 180 of the front wheel 154. An axle 182 is configured to pass through a center of the front wheel 154 and an aperture in each of the first leg 174 and the second leg 178. Any conventional axle structure and attachment structure can be used with the present suspension system. It is in the context of this type of vehicle and structure that the shock absorber of the present disclosure is used.

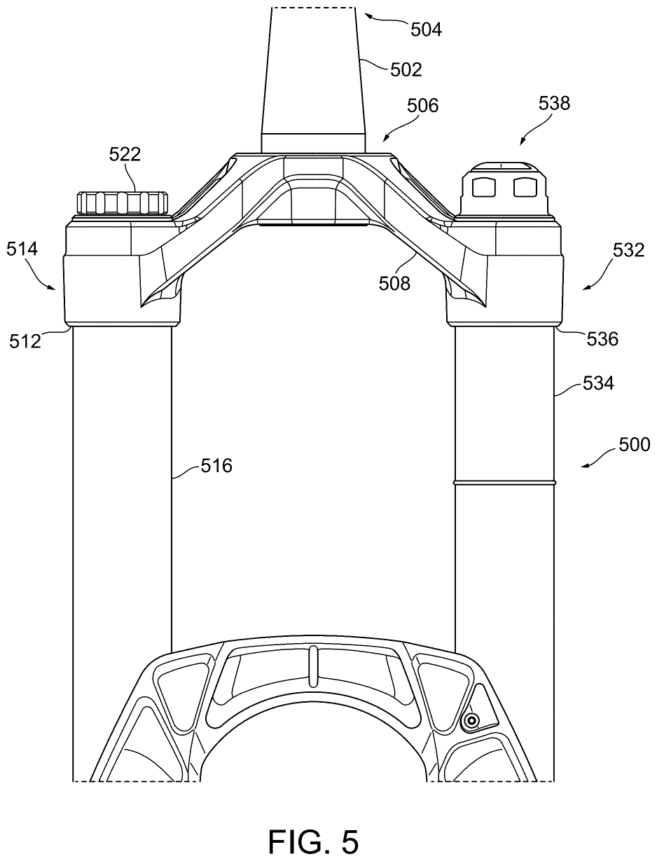

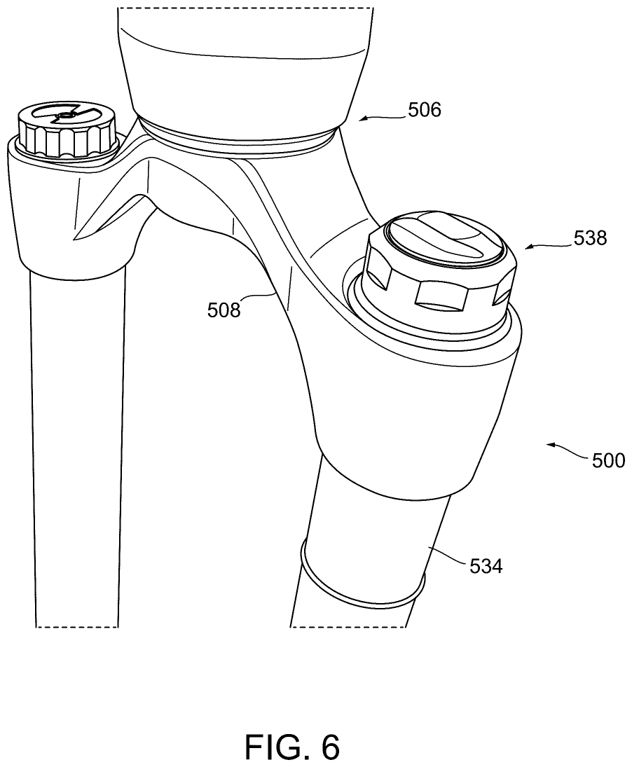

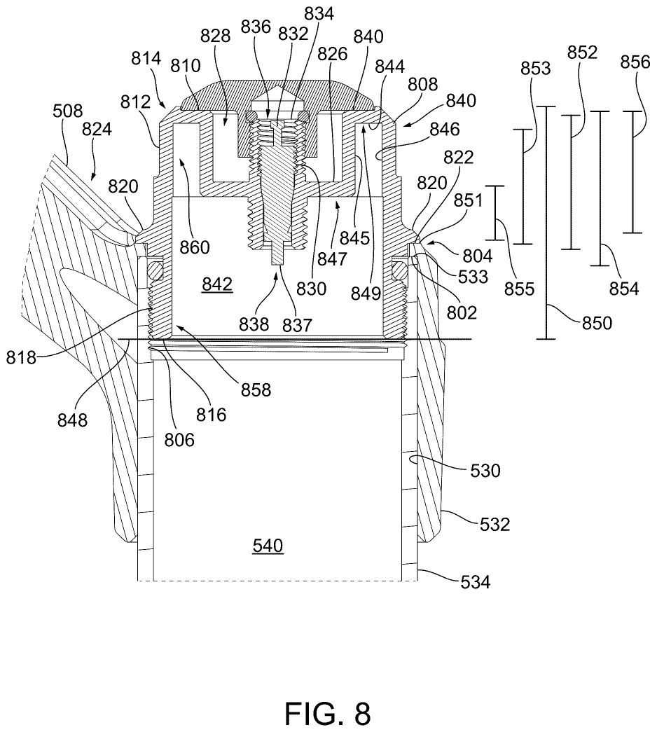

FIGS. 5-7 illustrate the overall configuration of the suspension system 500 that forms a part of or is designed to be used with the illustrated embodiments of FIGS. 8-15. Any feature not specifically recited or described in the present disclosure will be understood by a person of ordinary skill in the art to be selected from any of a conventional set of features. Indeed, many conventional features of a suspension may be stated broadly, and a person of ordinary skill in the art may easily make conventional substitutions without affecting the structure and function of the designs recited herein.

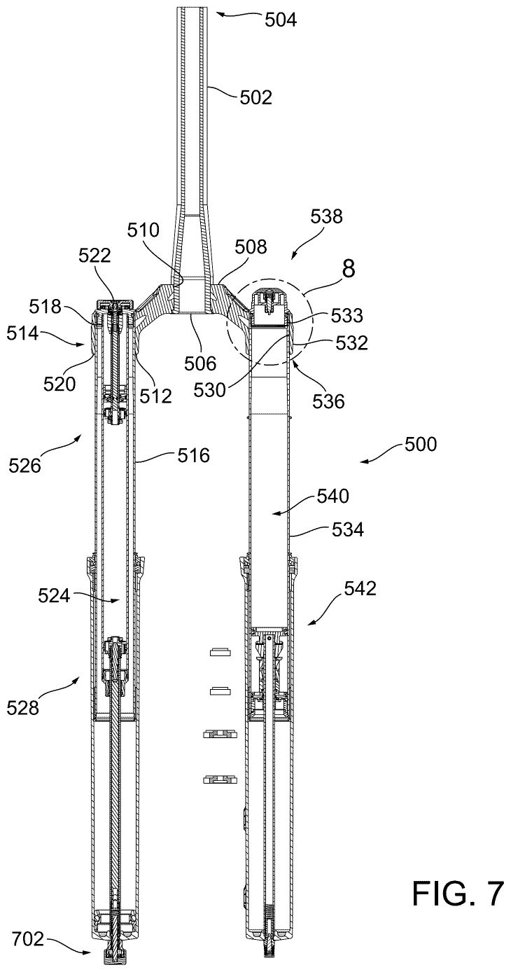

The suspension 500 may include a head tube 502 that is configured to be rotatably attached to the frame and handlebars of a bicycle (not shown) in a conventional manner at its top end 504. The bottom end 506 of the head tube 502 may be secured to a crown 508 in a conventional manner. The use of a single crown is conventional in bicycle applications. When a single crown 508 is used, the single crown 508 typically defines three apertures that pass therethrough. As is best seen in FIG. 7, the first aperture 510 traditionally is centrally located and allows the crown 508 to be secured to the head tube 502. Conventionally, the bottom end 506 of the head tube 502 may be positioned in the first aperture 510. The head tube 502 may thereby be secured to the first aperture 510, but may alternatively be secured to another area of the crown 508. The illustrated crown 508 is a single crown.

The second aperture 512 in the crown 508 may be defined near a first end 514 of the crown 508. This first end 514 is often considered to be the “right” end, as it typically is on the right side of the bicycle from the perspective of the rider. A right fork leg 516 may pass through at least a portion of the second aperture 512. The top surface 518 of the right fork leg is conventionally pressed into the lower end 520 of the second aperture 512 and may pass through at least a portion of the second aperture 512 until it contacts a shoulder (not visible in these FIGS.). The right fork leg 516 typically is internally threaded and mates with threads on a corresponding right fork leg cap 522. Tightening the right fork leg cap 522 onto the right fork leg 516 conventionally clamps the crown shoulder between the cap 522 and the leg 516 within the second aperture 512 and positions the right fork leg 516 in fixed position relative to the crown 508. In a conventional design, the right fork leg 516 is considered the “damping” leg. The interior cavities 524 in the right fork leg 516 may be at least partially filled with a damping fluid, which is typically a substantially incompressible fluid. Various damping structures, such as the damping structure 526 and one or more pistons 528, along with other damping mechanisms, may be included in the damping leg 516 to affect the rate at which portions of the fork legs compress relative to one another, as is conventional and well-known.

The third aperture 530 may be defined near a second end 532 of the crown 508. This second end is often considered to be the “left” end, as it typically is on the left side of the bicycle from the perspective of the rider. The top surface 533 of the left fork leg 534 is conventionally pressed into the lower end 536 of the third aperture 530 and may pass through at least a portion of the third aperture 530 until it contacts a shoulder (not visible in these FIGS., but which will be described in later FIGS.). The left fork leg 534 typically is internally threaded and mates with corresponding threads on a left fork leg cap 538. Tightening the left fork leg cap 538 onto the left fork leg 534 conventionally clamps the shoulder between the cap 538 and the leg 534 within the third aperture 530 and positions the left fork leg 534 in fixed position relative to the crown 508. In a conventional design, the left fork leg 534 is considered the “spring” leg. At least the upper interior cavity 540 of the left fork leg 534 may be filled with a compressible fluid, such as air, to form an air spring, as is conventional and well-known and as is used in the present embodiments. One or more pistons, such as the piston 542, along with other structures, may be included in the spring leg to affect the action of the air spring.

The present embodiments relate to the spring side of the suspension. More specifically, the present embodiments relate to the structure and function of the left fork leg cap, including its internal features, and the ways in which it is secured to spring leg 534. In the present disclosure, the term “stanchion” will be used. Applicant is using the term stanchion in its conventional manner. That is, Applicant is using the term “stanchion” to refer to the upper leg portion of the spring side of the suspension. The stanchion (conventionally and herein) remains in fixed position relative to the crown and a lower leg is permitted to reciprocate relative to the stanchion during use by a rider. The stanchions described and illustrated by Applicant can be selected from any conventional stanchion used with bicycle suspensions. In the present disclosure, the embodiments of FIGS. 8-10 and 12-15 use a conventional stanchion, and the embodiments of FIGS. 8-15 use a conventional single crown. The numbers used in FIGS. 5-7 are used in these embodiments. Only when a different structure for the stanchion or crown is necessary is a different number used to identify the different structure. A person of ordinary skill in the art can easily configure the present disclosure with any conventional stanchion.

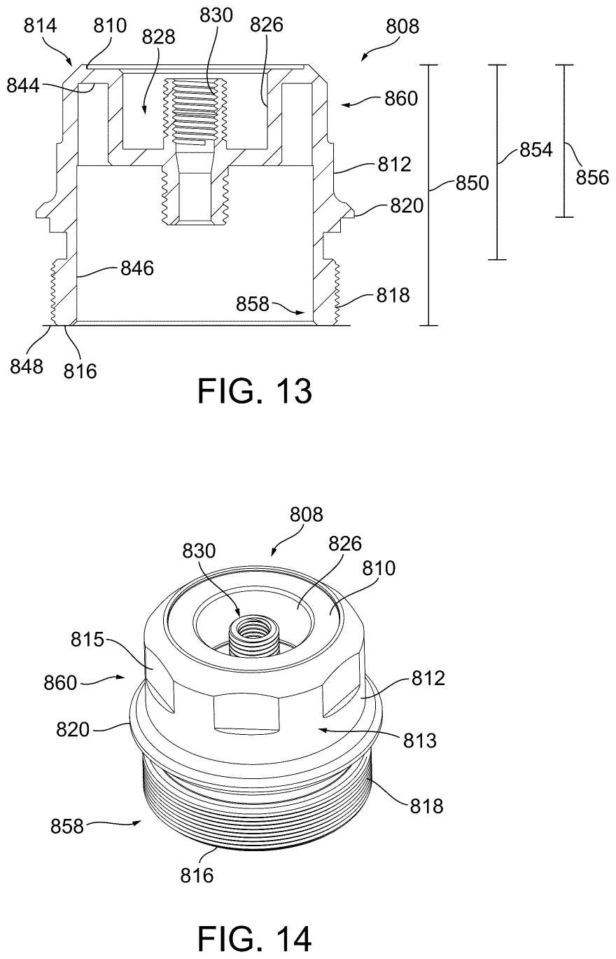

FIG. 8 shows the cap 808 as assembled with the remainder of the shock absorber. FIG. 13 shows a cross-sectional view of the cap 808 without the other portions of the shock absorber. FIG. 14 shows a perspective view of the cap 808 isolated from the other portions of the shock absorber. A person of ordinary skill in the art can understand that the cap 808 or any of the other disclosed embodiments can be incorporated into existing suspensions as an aftermarket or add-on product. The cap need not be assembled onto the remainder of the shock absorber and may be sold separately.

Turning first to FIG. 8, the top surface 533 of the stanchion 534 may be inserted into the third aperture 530 on the left side 532 of the crown 508. The top surface 533 may be inserted until it contacts the first surface 802 of the shoulder 804 defined on the crown 508 in or adjacent the third aperture 530. In many embodiments, the shoulder 804 may project inwardly into the third aperture 530. The stanchion 534 may include an internally threaded portion 806 at or near the top surface 533 of the stanchion 534. The stanchion is conventionally annular.

The cap 808 may include a top face 810 and at least one side 812 that extends from the top face 810. The top face 810 may be longitudinally spaced from or above the crown 508. As illustrated in the embodiment of FIG. 8, the top face 810 and the at least one side 812 may be integrally formed. The at least one side 812 may be continuous and is illustrated as a continuous annulus that integrally extends from a periphery 814 of the top face 810. In many embodiments, the at least one side 812 may be continuous in order to minimize the comingling of air surrounding the cap 808 and air or other compressible fluid within the cap 808. As may be best seen in FIG. 14, the outer surface 813 of the at least one side 812 may be provided with a plurality of flattened areas 815. The inclusion of flattened areas like the flattened areas 815 may be desirable so that a user can use a wrench, socket, or another tool to tighten the cap 808 onto the rest of the suspension assembly and to remove it when desired. The at least one side 812 may have and may terminate in an end surface 816. The cap 808 may include an externally threaded portion 818 on the at least one side 812 near the end surface 816 and longitudinally spaced from the top face 810. The external threaded portion 818 of the cap 808 may be configured to mate with the internal threaded portion 806 of the stanchion 534. In this way, the at least one side 812 may be considered to be an annular extender both of the stanchion 534 and of the top face 810. The first end 858 of the at least one side 812 may be configured to be attached to the stanchion 534. The second end 860 of the at least one side 812 may be configured to be attached to or integrally formed with the top face 810.

In many embodiments, the cap 808 may further include a finger 820 that may project outwardly from the at least one side 812. The finger 820 may be integrally formed with the at least one side 812. As shown in FIG. 8, when in an assembled position, the finger 820 may contact a second side 822 of the shoulder 804 on the crown 508. The finger may also be configured to contact another portion of the top surface 824 of the crown 508.

The top face 810 may have a discontinuous profile. In the embodiment shown in FIGS. 8, 13 and 14, there may be a concave recess 826 in the top surface 828 of the top face 810. The top surface 828 may define an aperture 830 therethrough. In the embodiment shown in FIG. 8, the aperture 830 is positioned generally centrally, which many may consider to be an advantageous position, and which is a conventional position in conventional caps. In the embodiment of FIG. 8, a spring control 832 may be positioned within the aperture 830. In many embodiments, a top surface 836 on the top end 834 of the spring control device 832 may be positioned outside an exterior surface 840 of the cap 808. A bottom surface 837 on a bottom end 838 of the spring control device 832 may be positioned within an interior volume 842 of the cap 808. In many embodiments, the spring control device 832 may be a Schrader valve as is illustrated with many of the embodiments herein. In other embodiments, a different valve or a different spring control device, such as a conventional adjuster, can be substituted therefor. In other embodiments, the aperture may be present, but may be fitted with a plug that allows access to the interior volume 842 of the cap 808 upon removal of the plug. The use of an aperture 830 is optional, and instead, the top cap may be a continuous surface, as will be described below.

The interior volume 842 of the cap 808 may be defined as the space that is bounded in part by the interior surface 844 of the top face 810 and the interior surface 846 of the at least one side 812. When there is an aperture in the top face, the volume is taken as if there were no aperture and the interior surface 844 were continuous in that area. The remaining boundary of the volume is defined by the plane 848. The plane 848 is an imaginary plane that is defined by creating a plane of the points forming the end surface 816 of the at least one side 812. It is hypothetically possible that the end surface 816 could have discontinuities. However, such a design is likely to be difficult and expensive to manufacture and difficult to easily assemble with the stanchion 534. However, if the end surface 816 were to have meaningful discontinuities, the plane 848 would be the plane that captures the greatest number of the points on the end surface 816. The interior volume of the cap 808 is desirably at least 6 ml.

As may be observed in the embodiment of FIG. 8, the interior surface 844 may be discontinuous. In the embodiment of FIG. 8, the interior surface 844 follows the shape of the top face 810 as whole. In the embodiment of FIG. 8, the top face 810 includes a concave recess 826. The interior surface 844 may therefore include a discontinuity or “step” as at 845. In such an embodiment, one portion 849 of the interior surface 844 of the top face 810 may be longitudinally spaced a first perpendicular distance from the plane 848 defined by the end surface 816. Another portion 847 of the interior surface 844 of the top face 810 may be longitudinally spaced a second perpendicular distance from the plane 848. In addition, the one portion 849 of the interior surface 844 of the top face 810 may be longitudinally spaced a first perpendicular distance 853 above the crown top surface 851 that is adjacent the aperture 530 in the crown 508. The other portion 847 of the interior surface 844 of the top face 810 may be longitudinally spaced a second perpendicular distance 855 above the crown top surface 851 that is adjacent the aperture 530 in the crown 508. In many embodiments, it is desirable for the entirety of the interior surface 844 of the top face 810 to be longitudinally spaced above the top surface 851 of the crown 508. However, it is most desirable for at least a portion of the interior surface 844 of the top face 810 to be longitudinally spaced above the top surface 851 of the crown 508.

In one exemplary embodiment, the minimum distance at least a portion of the interior surface 844 of the top face 810 is spaced above the top surface 851 of the crown 508 may be about 2.25 mm. The use of a 2.25 mm distance is calculated based a minimum desired volume of the cap 808. As will be described in greater detail below, it is desirable for the interior volume 842 of the cap to be at least 6 ml. At least a portion of that volume 842 may extend above the top surface 851 of the crown. In order for the volume 842 to be above the top surface 851 of the crown 508, at least a portion of the interior surface 844 of the top face 810 must also be spaced above the top surface 851 of the crown 508.

In the present embodiment, various structures and features may be described as being “above” the crown 508 or a portion of the crown 508. In use, the suspension 500 may be positioned in space in an orientation like that shown in FIG. 7. In the illustration of FIG. 7, the top end 504 of the head tube 502 may be considered to be above the remainder of the structure. The bottom end 702 of the structure may be considered to be below the remainder of the structure. Accordingly, when one structure is described herein as above or below another structure, a person of ordinary skill in the art will understand that the orientation of the suspension 500 to be considered in assessing whether something is above or below another structure is when the suspension is positioned as shown in FIG. 7. A person of skill in the art will understand that a suspension 500 may be positioned other than vertically when in use on a bicycle. Accordingly, the angle at which the suspension is placed in use may otherwise affect whether two parts are above or below one another. However, in the present disclosure, such differences in angle when the suspension is in use or otherwise in a position other than vertical is not relevant for describing the relative position of parts. Further, when evaluating whether something is longitudinally spaced from the crown and/or the top surface of the crown in the present disclosure, a person of ordinary skill in the art will understand that the relevant position of the measurement is the portion of the crown adjacent the relevant aperture. In the illustrated embodiments and in conventional designs, the crown may be angled or curved, such that it is at different vertical positions relative to the apertures at different positions along its width. Accordingly, the measurement of spacing may be made adjacent the shoulder of the crown.

In most embodiments, it is desirable for the lower end 858 of the cap 808 to be open. It is also desirable for the top end 533 of the stanchion 534 to be open. In most embodiments, it is desirable for the interior volume 842 of the cap 808 to be continuous and unbroken. In many embodiments, the interior volume 842 of the cap 808 may be configured to be substantially continuous with the interior volume 540 of the annular stanchion 534. In such an embodiment, the interior volume 842 of the cap 808 and the interior volume 540 of the stanchion 534 may effectively be one volume and the available interior volume of the stanchion 534 may be increased through the use of the cap 808.

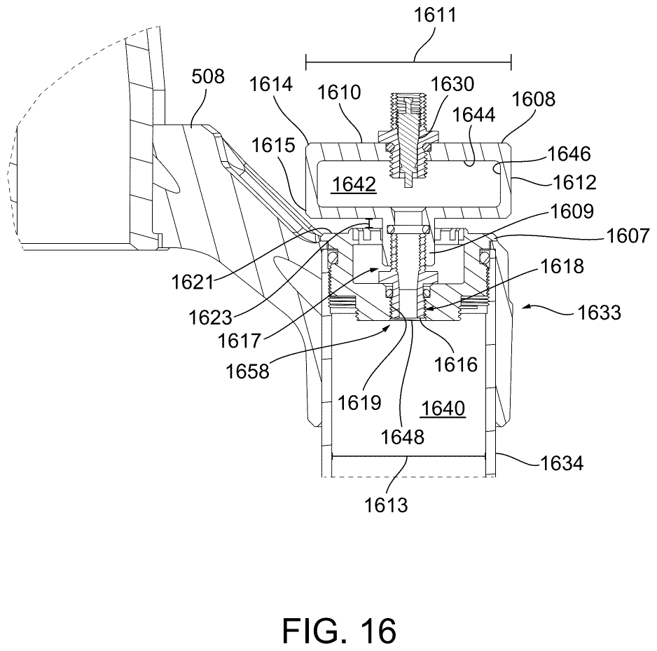

A person having ordinary skill in the art will understand that the volume 534 and the volume 842 need not be entirely continuous. In some embodiments, a baffle or barrier may extend over a portion of one or both of the volumes. Because air flows relatively easily at temperatures at which this structure will be used, the inclusion of a baffle or barrier is not likely to substantially affect the function of the device. In some embodiments, the baffle or barrier could be a finger or flange that extends across some or all of the volume. In other embodiments, the baffle or barrier could be ring-shaped and extend inwardly from the inside surface of either the stanchion or the cap. Another example with a structure that may function as a barrier is discussed in connection with the embodiment of FIG. 16, as will be described in greater detail below.

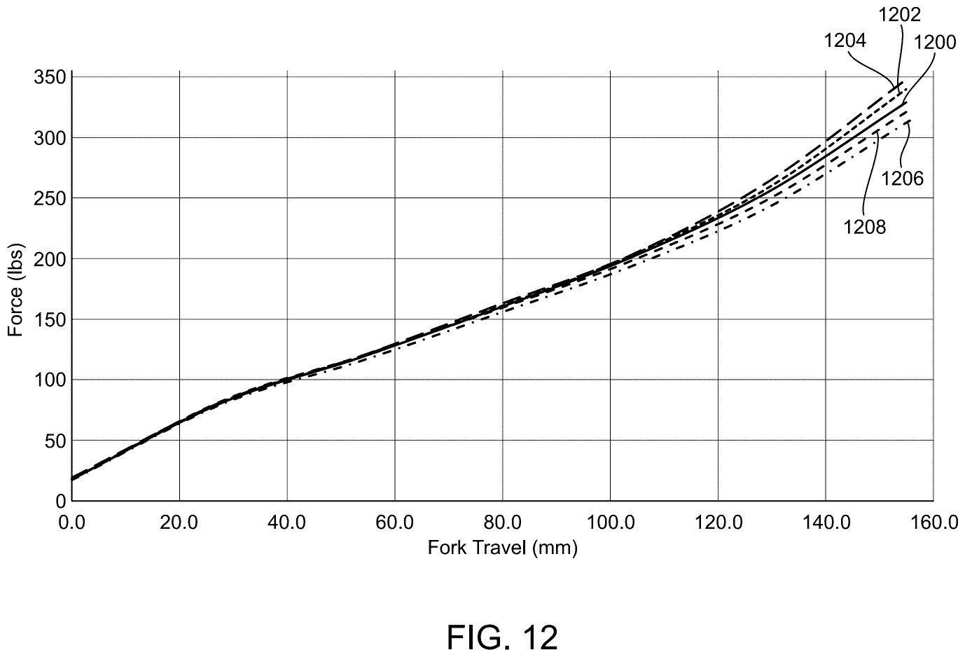

When a cap like the cap 808 is used on a stanchion 534, the additional air volume 842 in the cap may change the way in which the air spring functions and the feeling of the rider using the suspension. Turning to FIG. 12, the change in the force required to compress the leg at different travel lengths is shown. The Rock Shox Zeb was tested to determine the force in pounds that is present when the standard shock absorber is used. The testing was performed only on the “left” leg, so no damping attributable to the “right” leg is accounted for in the testing data. This is a standard testing protocol known to persons of skill in the art. The force measurement includes the force from the air spring and also includes the force from the compression in the lower leg and friction. However, the latter components are substantially unchanged when the air chamber volume is changed. Accordingly, the curve change can be attributed to the changes in spacers and the change in the cap. First, the Rock Shox Zeb was tested with the cap included from the manufacturer. This is the line that is labeled 1200. An air volume spacer that occupies about 6 ml of volume was inserted into the conventional system, and the test was repeated. This is the line that is labeled 1202. Two 6 ml air volume spacers were inserted into the conventional system, and the test was repeated. This is the line that is labeled 1204. A cap 808 that increases the air volume by about 12 ml was substituted for the standard cap, and the test was repeated. This substitute cap 808 may cause an increased air volume by having an internal volume of about 12 ml. This is the line that is labeled 1206. A 6 ml air volume spacer was inserted into the 12 ml cap 808, and the test was repeated. This insertion of the 6 ml spacer into the 12 ml cap nets a 6 ml increase in air volume compared to the standard cap. This is the line that is labeled 1208. This substitute cap 808 with the 6 ml air volume spacer may have a net internal volume of about 6 ml. An observation of the results indicates that at the full compression of the shock, there is a difference between about 8 pounds of force and about 11 pounds of force between each line. Accordingly, a volume change of 6 ml or more is desirable for an interior volume of a cap 808. A volume change greater than 6 ml is likely to produce an even better ride quality. However, because the cap 808 desirably fits within the space between the top of the stanchion and the frame when the handlebars turn, there is a natural limit for the possible size of the cap 808, particularly when it extends upwardly directly from the end of the stanchion.

Returning to FIGS. 13 and 14, in many embodiments, the length of parts and adjuncts of the cap 808 may be configured relative to one another. The cap 808 may have a cap length 850. The cap length 850 may be the distance between the plane 848 and a plane defined by the points on the cap 808 that are furthest from the plane 848. The spring control 832 may have a spring control length 852 (see FIG. 8). The spring control length 852 may be measured between the top surface 836 of the spring control 832 and the bottom surface 837 of the spring control 832. The cap length 850 may be greater or longer than the spring control length 852. In addition, the threaded portion 818 on the at least one side 812 may be spaced from the top face 810 by a distance or length 854. The length 854 may be greater than the spring control length 852. Further the exterior finger 818 may be spaced a distance 856 from the top face 810. The length or distance 854 may be greater than the length or distance 856. The bottom surface 837 of the spring control 832 may also be longitudinally spaced from the open upper end 533 of the stanchion 534 by at least a small distance and therefore the spring control 832 may not fall within the interior volume 540 of the stanchion 534.

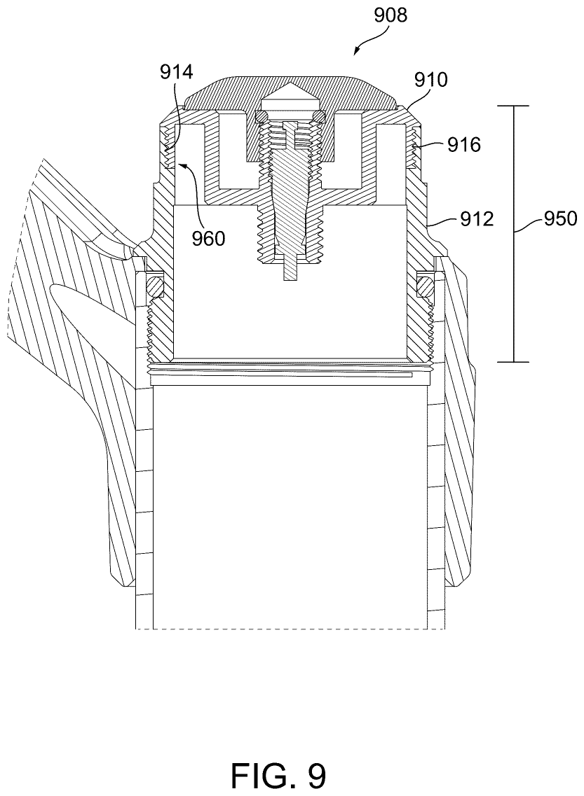

Turning now to the embodiment of FIG. 9, the embodiment of FIG. 9 is substantially identical to the embodiment of FIG. 8. However, some changes are present. Only the differences between the embodiment of FIG. 8 and the embodiment of FIG. 9 are discussed. Otherwise, a person of ordinary skill in the art will be able to compare the FIG. 8 and FIG. 9 embodiments and easily understand those common elements.

The embodiment of FIG. 9 is substantially the same as that of FIG. 8, except for the attachment of the top face to the at least one side. In the embodiment of FIG. 8, the top face 810 was integrally formed with the at least one side 812. In the embodiment of FIG. 9, the top face 910 is formed separately from the at least one side 912. In the embodiment shown in FIG. 9, the top face 910 may have a threaded finger 914. The at least one side 912 may have a corresponding threaded finger 916 at its second end 960. In the embodiment of FIG. 9, the top face 910 may be rotated so that it is attached to the second end 960 of the extender 912 through the mating threads.

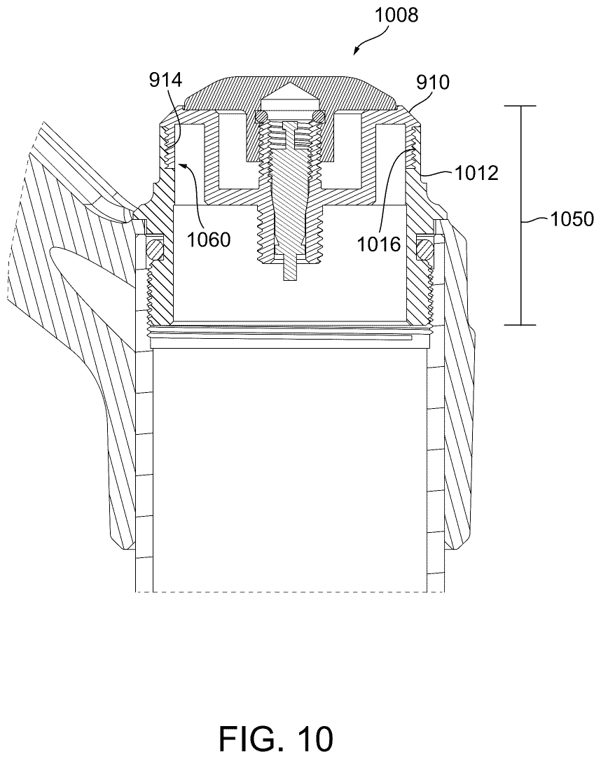

The embodiment of FIG. 10 is substantially the same as that of FIG. 9. The top face 910 is substantially identical in both embodiments. The top face 910 is formed separately from the at least one side 1012. In the embodiment shown in FIG. 10, the top face 910 may have a threaded finger 914. The at least one side 1012 may have a corresponding threaded finger 1016 at its second end 1060. In the embodiment of FIG. 10, the top face 910 may be rotated so that it is attached to the second end 1060 of the extender 1012 through the mating threads.

A comparison of the embodiments of FIG. 9 and FIG. 10 shows at least one advantage of using a configuration where the top face 910 is separated from the extender. In the embodiment of FIG. 9, the cap length is shown as 950. In the embodiment of FIG. 10, the cap length is shown as 1050. The cap length 950 of FIG. 9 is greater than the cap length 1050 of FIG. 10. Accordingly, if a designer desires to provide a greater adjustment in the volume of air added to the interior 540 of the stanchion 534, the designer may provide a plurality of lengths of the extender 912, 1012. The difference in lengths may affect the interior volume of the cap 908, 1008. This ability to select an appropriate volume may allow a user to have greater satisfaction because the user can make whatever adjustments the user believes are important and necessary simply by changing the extender used.

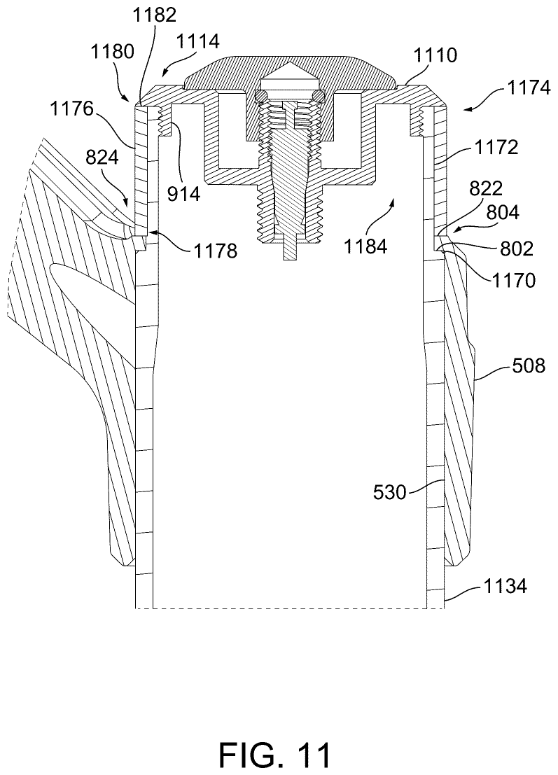

In the embodiment of FIG. 11, a top face similar to that in FIG. 9 may be used. The top face 1110 may include a threaded finger 914. The stanchion 1134 may be configured to have a stop 1170 that may be configured to make contact with the lower face 802 of the shoulder 802 that projects inwardly into the aperture 530 on the crown 508. However, instead of terminating at the shoulder 804 as in previous embodiments, the stanchion 1134 may have a narrowed area 1172 that may project upwardly above the shoulder 804 and above the crown 508. The narrowed area 1172 may have an internal threaded portion 1174. The threaded finger 914 may be configured such that its threaded portion is configured to attach to the threaded portion 1174 of the stanchion 1134. In such a configuration, only an interference fit is available to prevent the stanchion 1134 from sliding within the cavity 530.

Accordingly, an extender 1176 may be attached to the stanchion 1134 through a close interference fit or by a snap fit. The extender 1176 may be configured to allow its first end 1178 to engage the second side 822 of the shoulder 804 and a top surface 824 of the crown 508. The extender 1176 may also be configured to allow its second end 1180 to press against a lower surface 1182 of the peripheral edge 1114 of the top face 1110. When the top face 1110 is rotated so that the threaded finger 914 engages with the threaded portion 1174 of the stanchion 1134, the lower surface 1182 of the top face 1110 may press against the second end 1180 of the extender 1176. This force may press the first end 1178 of the extender 1176, which may cause the second end 1180 of the extender 1176 to press against the second face 822 of the shoulder 804. This pressing may effectively sandwich the shoulder 804 between the extender 1174 and the stop 1170 on the stanchion 1134. This sandwiching creates an effective attachment together of all the parts and may minimize relative sliding.

In many embodiments, the interior volume of the portion of the stanchion projecting above the crown may be configured to be substantially continuous with the interior volume 540 of the annular stanchion 534 within and below the crown. In such an embodiment, the interior volume all portions of the stanchion 534 may effectively be one volume and the available interior volume of the stanchion 534 may be increased through the use of the narrowed section 1184 projecting upwardly and above the crown 508.

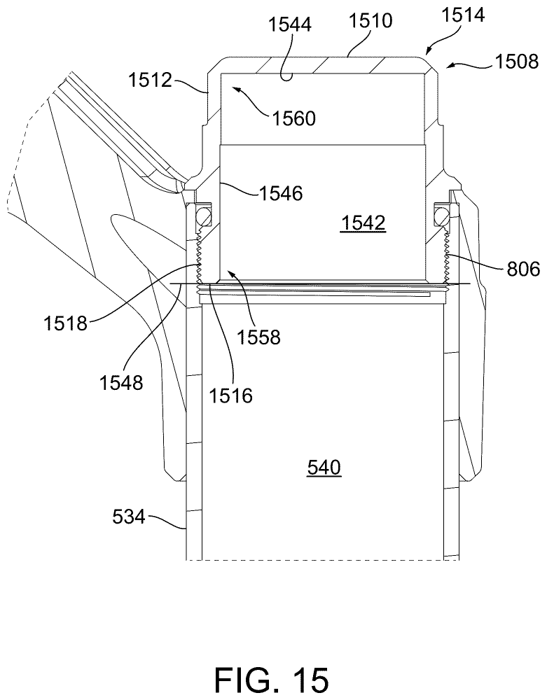

Turning now to FIG. 15, a simplified version of the cap 1508 is shown. The embodiment of FIG. 15 omits the aperture through the top face 1510 and the inclusion of the spring control present in the remaining embodiments. In the embodiment of FIG. 15, the top face 1510 may be continuous. The at least one side 1512 may extend from the peripheral edge 1514 to form an annular extender. The at least one side 1512 and the top face 1510 may be integrally formed. The at least one side 1512 may terminate in an end face 1516. The points of the end face 1516 may define a plane 1548.

The cap 1508 may include an external threaded portion 1518 on the at least one side 1512 near the end surface 1516 and spaced from the top face 1510. The external threaded portion 1518 of the cap 1508 may be configured to mate with the internal threaded portion 806 of the stanchion 534. The first end 1558 of the at least one side 1512 may be configured to be attached to the stanchion 534. The second end 1560 of the at least one side may be configured to be attached to the top face 1510.

The interior volume 1542 of the cap 1508 may be defined as the space that is bounded in part by the interior surface 1544 of the top face 1510 and the interior surface 1546 of the at least one side 1512. The remaining boundary of the volume 1542 may be defined by the plane 1548. The plane 1548 is an imaginary plane that is defined by creating a plane of the points forming the end surface 1516 of the at least one side 1512. The interior volume 1542 of the cap 1508 is desirably at least 6 ml.

In many embodiments, the interior volume 1542 of the cap 1508 may be configured to be substantially continuous with the interior volume 540 of the annular stanchion 534. In such an embodiment, the interior volume 1542 of the cap 1508 and the interior volume 540 of the stanchion 534 may effectively be one volume and the available interior volume of the stanchion 534 may be increased through the use of the cap 1508.

Another embodiment is shown in FIG. 16. In the embodiment of FIG. 16, the cap 1608 is shown as being attached through an aperture 1609 in the conventional cap 1607, rather than being substituted for the conventional cap 1607. In a conventional cap 1607, the aperture 1609 is configured to accommodate the spring control 1630. In the embodiment of FIG. 16, the cap 1608 is configured to have a size and shape that does not correspond to the size and shape of the stanchion 1634. Instead, the cap 1608 is configured to have a width or circumference 1611 greater than the width or circumference 1613 of the stanchion 1634.

The cap 1608 may include a top face 1610 and at least one side 1612 that extends from the top face 1610. The top face 1610 may be spaced from the crown 508. As illustrated in the embodiment of FIG. 16, the top face 1610 and the at least one side 1612 may be integrally formed. The at least one side 1612 may be discontinuous and is illustrated as integrally extending from a periphery 1614 of the top face 1610 to an angle 1615. The at least one side 1612 may then extend inwardly to a passageway 1617 that is open to the interior of the stanchion 1634. The at least one side 1612 may have and may terminate in an end surface 1616. The cap 1608 may include an externally threaded portion 1618 on the at least one side 1612 near the end surface 1616 and spaced from the top face 1610. The external threaded portion 1618 of the cap 1608 may be configured to mate with the internal threaded portion 1619 of the cap 1607.

The interior volume 1642 of the cap 1608 may be defined as the space that is bounded in part by the interior surface 1644 of the top face 1610 and the interior surface 1646 of the at least one side 1612. When there is an aperture in the top face 1610, the volume is taken as if there were no aperture and the interior surface 1644 were continuous in that area. The remaining boundary of the volume is defined by the plane 1648. The plane 1648 is an imaginary plane that is defined by creating a plane of the points forming the end surface 1616 of the at least one side 1612. The interior volume of the cap 1608 is desirably at least 6 ml.

In most embodiments, it is desirable for the lower end 1658 of the cap 1608 to be open. It is also desirable for the top end 1633 of the stanchion 1634 to be open. In most embodiments, it is desirable for the interior volume 1642 of the cap 1608 to be continuous and unbroken. In many embodiments, the interior volume 1642 of the cap 1608 may be configured to be substantially continuous with the interior volume 1640 of the annular stanchion 1634. In such an embodiment, the interior volume 1642 of the cap 1608 and the interior volume 1640 of the stanchion 1634 may effectively be one volume and the available interior volume of the stanchion 1634 may be increased through the use of the cap 808. In the embodiment of FIG. 16, the surface area of the lower end 1658 of the cap 1608 is illustrated as being smaller than the surface area of the top surface 1633 of the stanchion 1634. Because the stanchion 1634 and the cap 1608 are part of an air spring, the restriction in diameter and surface area at the bottom of the cap 1608 may not affect the function of the cap 1608 to provide an additional air volume within the spring.

Further, the embodiment of FIG. 16 illustrates an additional air volume provided by the cap 1608 that is at least partially remote from the stanchion 1634. In the illustrated embodiment, the inwardly extending part of the cap wall 1612 may be spaced from the top surface 1621 of the cap 1607 by a distance 1623. Accordingly, the use of such a combination of structures may allow air to flow from a stanchion volume 1640 through a passageway to the cap volume 1642.

As illustrated in the FIGS., the cap may have a variety of shapes, sizes, and attachment structures. A person of ordinary skill in the art will be able to make appropriate modifications to the cap and attachments for particular suspension and bicycle configurations, shapes, and sizes, without undue experimentation.

In the disclosed embodiments, structures and apertures of various sizes and shapes were illustrated. The precise configurations of these items are shown in an illustrative fashion only. A designer can easily change the shape, size, material, number, or other features of these items to achieve a particular characteristic that the designer may deem particularly desirable or helpful. These modifications are well within the knowledge of a designer having ordinary skill in the art. In addition, various embodiments may have disclosed a particular modification to a primary embodiment. A designer will be able to easily understand how to incorporate multiple changes to the design as disclosed and will also understand which changes cannot be incorporated in the same structure. A designer can do these substitutions without undue experimentation.

This detailed description in connection with the drawings is intended principally as a description of the presently preferred embodiments of the invention and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of any claims.

1. A shock absorber, comprising:
a cap configured to attach to the top end of a stanchion and having an interior volume of at least 6 ml.

2. The shock absorber according to claim 1, wherein
the cap has a top face and at least one side extending from the top face;
the at least one side terminates in an end surface and the end surface of the at least one side defines a plane; and
wherein the interior volume is defined by an interior surface of the top face, an interior surface of the at least one side and the plane defined by the end surface.

3. The shock absorber according to claim 1, wherein the interior volume is continuous.

4. The shock absorber according to claim 1, wherein the at least one side is continuous around a periphery of the top face.

5. The shock absorber according to claim 1, wherein the cap defines an aperture and the interior volume is measured as if the aperture were a continuous surface.

6. The shock absorber according to claim 1, wherein the interior volume extends from an interior surface of the top face to a top of a stanchion to which the cap is configured to be attached.

7. A shock absorber, comprising:
a cap configured to be assembled to a stanchion and having a cap length and an open end surface and defining an aperture spaced from the open end surface; and
a spring control positioned in the aperture and having a spring control length;
wherein the cap length is the greatest longitudinal distance between a plane defined by the open end surface of the cap and a plane defined by the points on the cap the furthest from the plane of the open end;
wherein the spring control length is the distance between a top surface of the spring control and a bottom surface of the spring control; and
wherein the cap length is greater than the spring control length.

8. The shock absorber according to claim 7, wherein the spring control is a valve.

9. The shock absorber according to claim 7, wherein the spring control is an adjuster.

10. The shock absorber according to claim 7, wherein the cap has at least one side extending from the top face.

11. The shock absorber according to claim 10, wherein the at least one side includes a threaded portion spaced from the top face by a second distance.

12. The shock absorber according to claim 10, further comprising a finger on the at least one side configured to engage a crown.

13. A shock absorber, comprising:
a crown; having
an aperture with an inward-projecting shoulder; and
a top surface adjacent the aperture;
an annular stanchion positioned in the aperture in contact with a first side of the shoulder;
an annular extender having a first end and a second end, the first end attached to the stanchion and in contact with at least a second side of the shoulder; and
a top face attached to the second end of the extender and having an interior surface;
wherein at least a portion of the interior surface of the top face is longitudinally spaced above the crown top surface.

14. The shock absorber according to claim 13, wherein the annular extender is integrally formed with the top face.

15. The shock absorber according to claim 13, wherein the annular extender is separate from the top face.

16. The shock absorber according to claim 13, wherein the top face and the annular extender are positioned adjacent one another.

17. The shock absorber according to claim 13, further comprising: a spring control attached to the cap, wherein the spring control has a first end on a first side of the top face and a second end on a second side of the top face.

18. The shock absorber according to claim 17, wherein an interior of the stanchion defines a volume and the spring control is positioned outside the volume.

19. The shock absorber according to claim 18, wherein the volume of the stanchion and a volume of the cap are continuous.

20. The shock absorber according to claim 13, wherein the at least a portion of the interior surface of the top face is longitudinally spaced at least about 2.25 mm above the crown top surface.
